(19) United States
(12) Patent Application Publication
(10) Pub. No.: US 2015/0333560 A1
(43) Pub. Date: Nov. 19, 2015

(54) Charging Station for an Electrical Device

(71) Applicant: Bury Sp.z.o.o., 39-300 Mielec (PL)

(72) Inventors: Mariusz Brach, Mielec (PL); Krzysztof Wdowiak, Baranow Sandomierski (PL)

(21) Appl. No.: 14/705,414

(22) Filed: May 6, 2015

(30) Foreign Application Priority Data
May 15, 2014 (DE) 10 2014 997 070.0

(51) Int. Cl. H02J 7/02; H02J 7/04

(52) U.S. Cl. CPC H02J 7/025; H02J 7/04

(57) ABSTRACT

The invention relates to a charging station for an electrical device that comprises at least one reception coil (8), wherein the charging station comprises a receiving device for receiving the electrical device and at least one charging coil (4), wherein the charging station comprises at least one guiding coil (12) that is arranged at least in part between the receiving device and the charging coil (4).

### FIELD OF THE INVENTION

The invention relates to a charging station for an electrical device that comprises at least one reception coil, wherein the charging station comprises a receiving device for receiving the electrical device, and at least one charging coil.

### BACKGROUND

Nowadays, a plurality of different electrical devices comprise energy storage devices, by way of example rechargeable batteries that can be charged in a wireless manner. A corresponding charging station comprises at least one charging coil that can be influenced with an alternating current. In particular, a magnetic field that changes over time occurs. If a reception coil of an electrical device is arranged in this magnetic field that changes over time, an electrical current is induced in this reception coil by means of the changing magnetic field and said electrical current can be used so as to charge the rechargeable battery. Electrical devices that can be charged in this manner can be by way of example mobile radio devices, tablet pcs, smartphones, MP3 players or other electrical or electronic portable devices. However, batteries and rechargeable batteries of electric cars and other electrically operated vehicles can also be charged in this manner so that these vehicles are also understood to be electrical devices in the sense of the present application.

Consequently, a charging station can assume the widest variety of forms and shapes. The charging station can thus be embodied in the form of a holding device for a mobile radio device or another portable data processing device or telecommunications device. In contrast, the charging station for electrically operated vehicles is a correspondingly equipped parking space in which the at least one charging coil is arranged by way of example below the actual parking surface that in this case forms the receiving device. In particular for portable electronic or electrical devices, it is possible by way of example to also embed the charging station in furniture, by way of example table surfaces. In this case, it is possible to charge by way of example mobile telephones or telecommunications devices during a visit to a café or restaurant by means of placing the device on a specific site of the table. A corresponding charging station can be constructed for nearly all electrical devices that are embodied so as to be charged inductively, and said charging station is covered by this application.

A charging station of this type in the form of a holding device for a mobile radio device is disclosed in US 2010/0315039 A1 and U.S. Pat. No. 7,392,068 B2. The holding device comprises at least one charging coil that can cooperate with the reception coil of the mobile radio device in such a manner that it is possible to wirelessly charge by way of example the rechargeable battery of the mobile radio device. This has the advantage that neither an exact positioning of the mobile radio device in the receiving device of the holding device nor a plug connection between the mobile radio device and a corresponding socket or a plug of the holding device is necessary in order to charge the mobile radio device that can be by way of example a mobile telephone, a smartphone or another mobile communication means.

DE 10 2012 217 424 A1 discloses a charging station for electrically operated vehicles in which a load impedance is arranged in the motor vehicle that is to be charged in order to be able to set the electrical power that is to be transferred. In particular, safety regulations are therefore to be observed that by way of example relate to maximal permitted heating of objects that are arranged between the charging coil and the reception coil.

The at least one charging coil of the charging station and the at least one reception coil of the electrical device together form a transformer by means of which the power is transferred. However, since the two coils are positioned spaced apart with respect to one another and are not arranged about a common core, the proportion of the magnetic flux that is generated in the at least one charging coil and that also flows through the reception coil of the electrical device is reduced with respect to that of a conventional transformer that comprises a core. This leads to an undesired and almost uncontrolled emission of electromagnetic fields, whereby other electrical or electronic devices in the proximity of the charging station can be influenced and/or disturbed. This is in particular problematic in the case of charging stations that are arranged in motor vehicles since a plurality of further electronic devices, by way of example a car radio or a navigation system are arranged in the direct proximity of the charging station. Added to this, in the case of charging stations for charging electrically operated vehicles, the spacing between the at least one charging coil and the at least one reception coil is embodied as very large and in addition is embodied to induce a large electrical current in the at least one reception coil in order to charge the in part very large capacity rechargeable batteries and energy storage devices of the vehicle. Consequently, it is necessary to generate intense electromagnetic fields in the at least one charging coil which leads to an increased emission of electromagnetic fields also in undesirable directions.

### SUMMARY

The object of the invention is therefore to further develop a charging station for an electrical device in such a manner that the electromagnetic radiation that is emitted in undesired directions is reduced. The invention achieves the proposed object by means of a charging station in accordance with the preamble of claim 1 and said charging station is characterized by virtue of the fact that the charging station comprises at least one guiding coil that is arranged at least in part between the receiving device and the charging coil.

The at least one guiding coil that can be by way of example an individually closed winding embodied from an electrically conductive material reduces the proportion of the electromagnetic radiation that is emitted in undesired directions. The at least one guiding coil is also located in the electromagnetic field of the at least one charging coil if an electrical alternating current flows through said charging coil. Consequently, the guiding coil is located in a magnetic field that changes over time so that an electrical current is induced within the guiding coil and a magnetic field is generated by means of said electrical current and said magnetic field counteracts the magnetic field that is generated by means of the at least one charging coil. In this manner, at least one part of the magnetic field of the charging coil is compensated for and the electromagnetic radiation that is emitted is thus reduced.

It is preferred that the at least one guiding coil is located entirely between the at least one charging coil and the receiving device in which the electrical device can be received. As a consequence, the effect of the at least one guiding coil is maximised and the number of windings that are required and therefore the amount of the electrically conductive material that is required to produce the guiding coil is reduced. As a consequence, the production process becomes quicker, simpler and more cost-effective.

The guiding coil advantageously comprises fewer windings than the at least one charging coil. Since as a result of the at least one guiding coil, it is not necessary to transfer power to the at least one reception coil of the electrical device, rather it is only necessary to compensate for disruptive parts of the magnetic field that are emitted and extend in undesired directions, it is sufficient to equip the at least one guiding coil with fewer windings than the at least one charging coil. In specific application areas it is sufficient to use only a single closed winding as a guiding coil. As a consequence, the amount of electrically conductive material that is required is further reduced.

In a preferred embodiment, the at least one guiding coil is connected in an electrical manner to a reference potential, in particular is earthed. As a consequence, the emissions of the electrical conductor that forms the at least one guiding coil are limited and in addition, the electrostatic charges and corresponding forces that by way of example remain after disconnecting the electrical alternating current that is flowing through the at least one charging coil are reduced or rather avoided.

It has been found to be advantageous that a cross sectional surface of the at least one guiding coil is larger than a cross sectional surface of the at least one charging coil. In this manner, it is ensured that the influence of the at least one guiding coil on the desired magnetic flux in the direction of the at least one reception coil of the electrical device is as small as possible and the electrical current in the at least one guiding coil is in particular induced by means of the disrupting portions of the magnetic field and the electromagnetic radiation that is emitted. Clearly stated, in this case the at least one guiding coil is not located in the region of the field lines that leave the at least one charging coil and extend through the at least one reception coil of the electrical device, rather in particular said guiding coil interferes with the magnetic field lines that do not extend through the reception coil and that consequently form the undesired, scattered magnetic field lines.

In a particularly preferred embodiment, the at least one guiding coil is a printed circuit, in particular on a circuit board. In this manner, the at least one guiding coil can be produced in a particularly simple and cost effective manner that saves material and said guiding coil can subsequently be constructed in the charging station in a particularly constructively simple manner. In addition, it is possible in this manner to exchange defective or damaged guiding coils particularly easily, in that by way of example the circuit board that carries the at least one guiding coil is removed and replaced with another.

It is preferred that the circuit board is the circuit board of the antenna coupling. This circuit board is already present in most charging stations, in particular for mobile electrical or electronic communications devices. Additional construction space is not required in the charging station as a result of the at least one guiding coil being attached in the form of a printed circuit to this already present circuit board before mounting the circuit board in the charging station, so that the charging station can be embodied in a constructively small and compact manner despite the additionally present at least one guiding coil.

The at least one guiding coil can be advantageously embodied from at least one metal wire, in particular from copper, silver, silver-coated metal or metal sheet. Clearly, other electrically conductive materials are also feasible in which an electrical current can be induced by means of a magnetic field that changes over time.

It is preferred that the at least one guiding coil comprises a rectangular or circular cross section. It is particularly advantageous that the cross section of the at least one guiding coil comprises the identical geometrical form as the cross section of the at least one charging coil. In this manner, it is ensured that the two coils can be arranged in a concentric manner with respect to one another so that the spacing between the at least one guiding coil and the corresponding at least one charging coil is constant at each site of the periphery of the two coils so that also the damping and guiding effect of the at least one guiding coil is identically large at each site along the periphery of the two coils.

The at least one charging coil can be embodied in such a manner that it can be displaced relative to the receiving device in order by way of example to be able to allow for an imprecise positioning of the electrical device in the receiving device. Advantageously in this case, the at least one guiding coil is also embodied in such a manner that it can be displaced and particularly advantageously said guiding coil is mechanically coupled to the at least one charging coil so that the two coils can only be displaced in concert with one another. In this manner, on the one hand, it is achieved that even in the case of the electrical device being positioned imprecisely in the receiving device, the maximal power can be transferred from the at least one charging coil to the at least one reception coil and simultaneously an optimal shielding and guiding of the undesired magnetic field lines is achieved by means of the at least one guiding coil.

It has been found to be advantageous if the charging station comprises multiple charging coils and multiple, in particular just as many, guiding coils. In this manner it is ensured that for each of the charging coils at least one guiding coil is present. Independently of whether one or multiple charging coils are present, it can be expedient to provide multiple guiding coils for one charging coil and said guiding coils can be arranged in different spaces with respect to the respective charging coil. The different guiding coils can comprise different or identical diameters and/or different or identical geometric cross sectional shapes and/or identical or different numbers of windings. In this manner, it is possible in dependence upon the respective requirements and demands on an individual basis to construct individual guides in order to be able to influence the magnetic field that changes over time and that is generated by means of the charging coil.

It is preferred that at least one electrical conductor that forms the at least one guiding coil extends in a meandering manner around the periphery of the at least one guiding coil. In this manner, a larger proportion of the undesired magnetic field that does not extend through the reception coil of the at least one electrical device is captured and is “rendered harmless”.

### DESCRIPTION OF THE DRAWINGS

An exemplary embodiment of the present invention is further explained hereinunder with the aid of the attached drawing. In the drawing

FIG. 1—illustrates the schematic view of a part of a charging station in accordance with a first exemplary embodiment of the present invention,

FIGS. 2 to 4—illustrate schematic plan views of different coil arrangements in a charging station in accordance with a further exemplary embodiment of the present invention.

### DETAILED DESCRIPTION

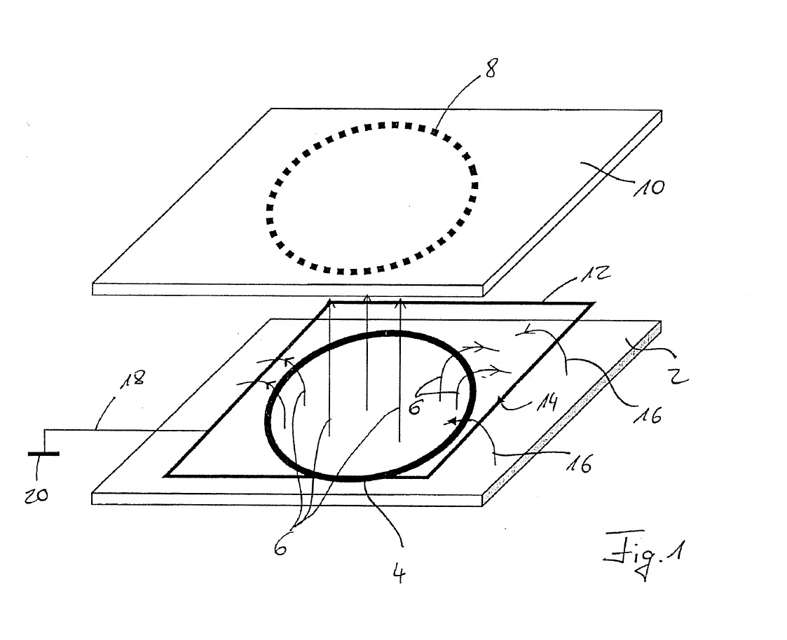

FIG. 1 illustrates the schematic view of a part of a charging station in accordance with a first exemplary embodiment of the present invention. At least one charging coil 4 is arranged on a component 2 of the charging station, said component can be by way of example be a ferrite shielding and said charging coil can be influenced with an electrical alternating current. As a consequence, an alternating magnetic field occurs that is illustrated by means of schematically described charging field lines 6. It is evident that a part of the charging field lines 6 in the illustrated exemplary embodiment extend perpendicularly upwards and consequently through a reception coil 8 that is part of an electrical device, of which only a base component 10 is illustrated that by way of example can likewise be a ferrite shielding. These charging field lines 6 that extend perpendicularly upwards in FIG. 1 consequently likewise extend through the reception coil 8 and ensure in this manner that a current is induced in the reception coil 8 in the electrical device and a rechargeable battery or a battery of the electrical device can be charged by means of said current. However, as is likewise evident in FIG. 1, not all the charging field lines 6 extend in this direction. In addition, the magnetic field is illustrated by means of curved illustrated charging field lines 6 that do not extend through the reception coil 8. These charging field lines are not desired and allow an emission of electromagnetic radiation that can disrupt the adjacent and surrounding electrical and/or electronic devices and can possibly cause adverse effects on the health of users.

The figure illustrates a guiding coil 12 for reducing the magnetic flux that is illustrated by means of these charging field lines 6 and said guiding coil comprises at least one closed winding of an electrical conductor. Since this magnetic field that is in itself changing and that is illustrated by means of the charging field lines 6, an electrical current is induced in the guiding coil 12 and the direction of said current is indicated by means of the arrowhead 14. This current consequently leads to the generation of a alternating magnetic field that is illustrated by means of guiding field lines 16. It is evident that the guiding field lines 16 act against the charging field lines 6 that do not extend through the reception coil 8. The intensity of the magnetic field that does not extend through the reception coil 8 is clearly reduced in this manner so that the emission of electromagnetic radiation is also reduced.

The guiding coil 12 is connected to a reference potential 20 by way of an electrical line 18.

It is evident in FIG. 1 that the guiding coil 12 is embodied as rectangular while the charging coil 4 comprises a circular cross section. This is a possible however not necessary configuration. However, it is preferred that the one cross sectional surface of the guiding coil 12 is larger than the cross sectional surface of the charging coil 4. In this manner it is ensured that the electrical conductor that forms the guiding coil 12 is located in the region of the charging field lines 6 that do not extend through the reception coil 8.

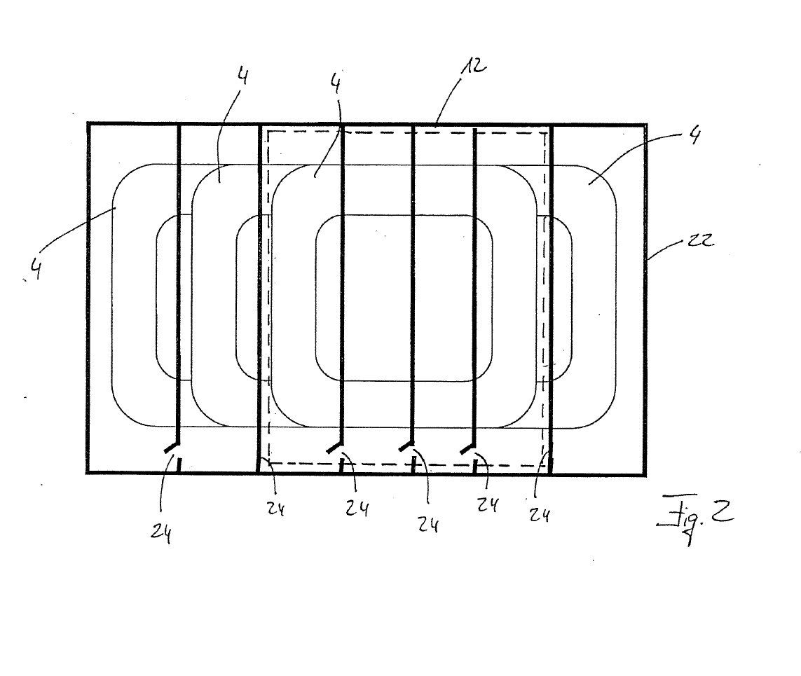

FIG. 2 illustrates a schematic plan view of the coil arrangement of a charging station in accordance with a further exemplary embodiment of the present invention. Said coil arrangement comprises four charging coils 4 of which only one is active, namely the one indicated by the continuous line second from the right-hand side in FIG. 2. By virtue of the fact that multiple charging coils 4 are present, it is possible to react to the electrical device being positioned in a different manner in that by way of example different charging coils 4 can be actively used in order to charge the rechargeable battery or the battery of the electrical device. In addition to the multiple charging coils 4, a conductor arrangement 22 is illustrated in which the conductors that in each case extend in FIG. 2 from above downwards comprise a switching element 24. In the illustrated exemplary embodiment, four of the switching elements 24 are open and two are closed. In this manner, a rectangular guiding coil 12 is formed on whose inner side a dashed line extends for improved clarity. It is evident that as a result of opening or rather closing different switching elements 24, the size and the position of the guiding coil 12 can be changed and by way of example can be adjusted to other active charging coils 4. Similarly, it is feasible to also achieve different forms of guiding coils 12 in this manner. The individual switching elements 24 can be by way of example mechanical connecting pieces or a semiconductor connecting piece that can be brought into an opened and a closed state.

A similar conductor arrangement 22 can be used likewise with different switching elements 24 if at least one of the charging coils that is present is embodied in such a manner that it can be displaced, and thus the position of the charging coil 4 can be changed relative to the rest of the charging station. Even in this case it can be expedient to open or to close individual switching elements in order to adjust the position and size of the guiding coil 12 to the changed position of the charging coil. Alternatively or in addition thereto it is possible for this purpose to couple the guiding coil 12 to a charging coil 4 that is embodied in such a manner that it can move and in this manner it is possible to achieve that the charging coil 4 and guiding coil 12 can be displaced in concert with one another.

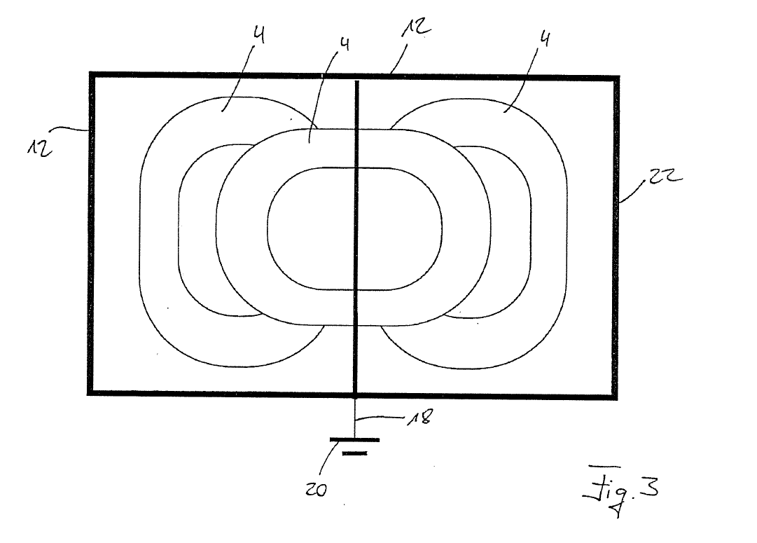

FIG. 3 illustrates a further arrangement that comprises three charging coils 4. The charging coils 4 are embodied as oval in the exemplary embodiment that is illustrated in FIG. 3. One of the charging coils 4 is positioned in a transverse manner, the other two in a normal manner. In the illustrated exemplary embodiment, the conductor arrangement 22 that is connected to the reference potential 20 by way of the electrical line 18 does not comprise switching elements 24 by means of which it is possible to open or close the individual elements of the conductor arrangement 22. On the contrary, the conductor arrangement 22 in each case forms the guiding coil 12 that is required for all three charging coils 4. The right-hand side loop and the left-hand side loop in FIG. 3 can be used separately as guiding coils 12 for the charging coil 4 that is arranged on the right-hand side and for the charging coil 4 that is arranged left-hand side, said charging coils being arranged in a normal manner, while the outer ring of the conductor arrangement 22 is used as a corresponding guiding coil 12 for the middle charging coil 4 that is arranged in a transverse manner.

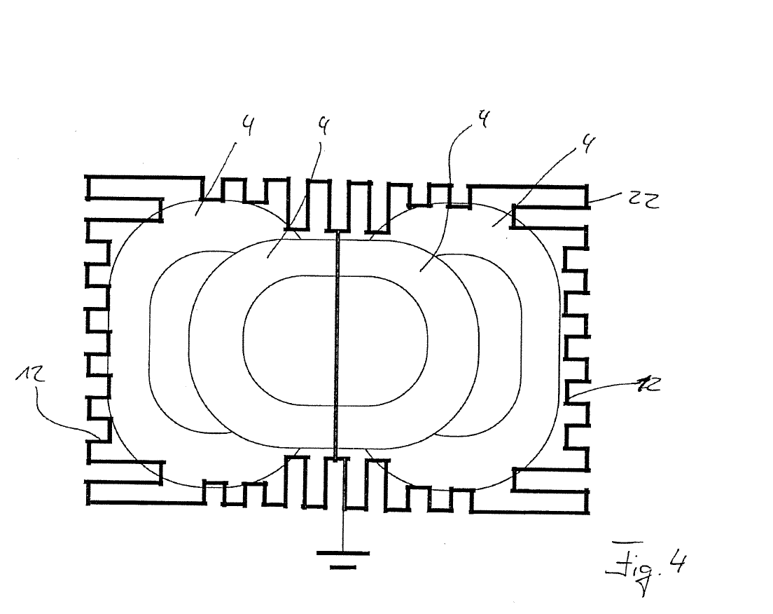

FIG. 4 illustrates a similar arrangement in which only the outer ring of the conductor arrangement is embodied in a meandering manner in order thus to maximise the functionality and the effect and thus to reduce by way of example the number of the required windings of the guiding coil 12.

### LIST OF REFERENCE NUMERALS

2 Component
4 Charging Coil
6 Charging Field Lines
8 Reception coil
10 Base Component
12 Guiding Coil
14 Arrowhead
16 Guiding Field Line
19 Electrical Line
20 Reference Potential
22 Conductor Arrangement
24 Switching Element

1. Charging station for an electrical device that comprises at least one reception coil (8), wherein the charging station comprises a receiving device for receiving the electrical device and at least one charging coil (4), wherein the charging station comprises at least one guiding coil (12) that is arranged at least in part between the receiving device and the charging coil (4) so that by means of a first magnetic field that is generated by means of an electrical current flow in the charging coil, an electrical current is induced in the at least one guiding coil and said electrical current generates a second magnetic field that is aligned opposing to the first magnetic field.

2. Charging station according to claim 1, wherein the at least one guiding coil (12) comprises fewer windings than the at least one charging coil (4).

3. Charging station according to claim 1, wherein the at least one guiding coil (12) is connected in an electrical manner to a reference potential (20), in particular is earthed.

4. Charging station according to claim 1, wherein a cross sectional surface of the at least one guiding coil (12) is larger than a cross sectional surface of the at least one charging coil (4).

5. Charging station according to claim 1, wherein the at least one guiding coil (12) is a printed circuit, in particular on a circuit board.

6. Charging station according to claim 6, characterized in that the circuit board is the circuit board of the antenna coupling.

7. Charging station according to claim 1, wherein the at least one guiding coil (12) is embodied from at least one metal wire, in particular from copper, silver or silver-coated metal.

8. Charging station according to claim 1, wherein the at least one guiding coil (12) comprises a rectangular or circular cross section.

9. Charging station according to claim 1, wherein the charging station comprises multiple charging coils (4) and multiple, in particular just as many, guiding coils (12).

10. Charging station according to claim 1, wherein at least one electrical conductor that forms the at least one guiding coil (12) extends around the periphery of the at least one guiding coil (12) in a meandering manner.
